(19) United States
(12) Patent Application Publication
(10) Pub. No.: US 2002/0037979 A1
(43) Pub. Date: Mar. 28, 2002

(54) MIXED ZIEGLER/METALLOCENE CATALYSTS FOR THE PRODUCTION OF BIMODAL POLYOLEFINS

(76) Inventors: ROBERT CHARLES JOB, BOUND BROOK, NJ (US); JESSICA ANN COOK, CLINTON, NJ (US); SUN-CHUEH KAO, BELLE MEAD, NJ (US)

Correspondence Address: UNION CARBIDE CORPORATION, LAW DEPARTMENT E205, 39 OLD RIDGEBURY ROAD, DANBURY, CT, 068170001

(21) Appl. No.: 09/473,491

(22) Filed: Dec. 28, 1999

(51) Int. Cl. C08F 4/44

(52) U.S. Cl. 526/119; 526/160; 526/943; 526/114; 526/118; 526/113; 502/103; 502/104; 502/113; 502/152; 502/132; 502/133

(57) ABSTRACT

A self-supported hybrid olefin polymerization catalyst comprising a Ziegler-Natta component and a metallocene component whereby the metallocene component is affixed to the Ziegler-Natta component is disclosed. In the hybrid catalyst, the Ziegler-Natta component includes a solid complex of magnesium, transition metal, and alkoxide moieties where the transition metal is selected from one or more metals having an oxidation state of +3, +4, +5, and mixtures thereof. A method of making the hybrid catalyst and a method of polymerizing olefins using the hybrid catalyst also are disclosed. The hybrid catalyst is capable of producing polyolefins having a broad molecular weight, or bimodal distribution in high yield.

### BACKGROUND OF THE INVENTION

1. Field of the Invention

The present invention relates to a hybrid catalyst system containing a Ziegler-Natta portion and a metallocene portion, which is useful for producing broad molecular weight and bimodal polyolefins. The invention also relates to methods of making the hybrid catalyst and the use thereof in making polyolefins having broad molecular weight and its use in making bimodal polyolefins.

2. Description of Related Art

For certain applications of polyethylene, toughness, strength and environmental stress cracking resistance are important considerations. These properties are enhanced when the polyethylene is of high molecular weight. However, as the molecular weight of the polymer increases, the processability of the resin usually decreases. By providing a polymer with a broad or bimodal molecular weight distribution, the properties characteristic of high molecular weight resins are retained and processability, particularly extrudability, is improved.

Bimodal molecular weight distribution of a polyolefin indicates that the polyolefin resin comprises two components of different molecular weight, and implicitly requires a relatively higher molecular weight component and low molecular weight component. A number of approaches have been proposed to produce polyolefin resins with broad or bimodal molecular weight distributions. One is post-reactor or melt blending, in which polyolefins of at least two different molecular weights are blended together before or during processing. U.S. Pat. No. 4,461,873 discloses a method of physically blending two different polymers to produce a bimodal polymeric blend. These physically produced blends, however, usually contain high gel levels, and consequently, they are not used in film applications and other resin applications because of deleterious product appearance due to those gels. In addition, this procedure of physically blending resins suffers from the requirement for complete homogenization and attendant high cost.

A second approach to making bimodal polymers is the use of multistage reactors. Such a process relies on a two (or more) reactor set up, whereby in one reactor, one of the two components of the bimodal blend is produced under a certain set of conditions, and then transferred to a second reactor, where a second component is produced with a different molecular weight, under a different set of conditions from those in the first reactor. These bimodal polyolefins are capable of solving the above-mentioned problem associated with gels, but there are obvious process efficiency and capital cost concerns when multiple reactors are utilized. In addition, it is difficult to avoid producing polyolefin particles that have not incorporated a low molecular weight species, particularly, when the high molecular weight component is produced in the first reactor.

A third and more desirable strategy is direct production of a polyolefin having a broad or bimodal molecular weight distribution by use of a catalyst mixture in a single reactor. In fact, Scott, Alex, “Ziegler-Natta Fends off Metallocene Challenge,” Chemical Week, pg. 32 (May 5, 1999) states that one “of the holy grails [of polyolefin research] is getting bimodal performance in one reactor for PE and PP” (quoting Chem Systems consultant Roger Green). The art recently has attempted to solve the aforementioned problems by using two different catalysts in a single reactor to produce a polyolefin product having a broad molecular weight distribution, or bimodal molecular weight distribution. Such a process is reported to provide component resin portions of the molecular weight distribution system simultaneously in situ, the resin particles being mixed on the subparticle level. For example, U.S. Pat. Nos. 4,530,914 and 4,935,474 to Ewen relate to broad molecular weight distribution polyolefins prepared by polymerizing ethylene or higher alpha-olefins in the presence of a catalyst system comprising two or more metallocenes each having different propagation and termination rate constants and aluminoxane. Similarly, U.S. Pat. No. 4,937,299 to Ewen relates to the production of polyolefin reactor blends in a single polymerization process using a catalyst system comprising two or more metallocenes having different reactivity ratios for the monomers being polymerized.

It is known that metallocenes may be affixed to a support to simulate an insoluble catalyst. U.S. Pat. No. 4,808,561 discloses reacting a metallocene with an aluminoxane and forming a reaction product in the presence of a support. The support is a porous material like talc, inorganic oxides such as Group IIA, IIIA IVA OR IVB metal oxides like silica, alumina, silica-alumina, magnesia, titania, zirconia and mixtures thereof, and resinous material such as polyolefins like finely divided polyethylene. The metallocenes and aluminoxanes are deposited on the dehydrated support material.

An advantage of a homogeneous (metallocene) catalyst system is the very high activity of the catalyst and the narrow molecular weight distribution of the polymer produced with a metallocene catalyst system. The metallocene catalysts suffer from a disadvantage in that the ratio of alumoxane cocatalyst to metallocene is high. In addition, the polymers produced using metallocene catalysts often are difficult to process and lack a number of desirable physical properties due to the single homogeneous polymerization reaction site.

Heterogeneous catalyst systems also are well known, and typically are used to prepare polymers having broad molecular weight distribution. The multiple (e.g., heterogeneous) active sites generate a number of different polymer particles of varying length and molecular weight. These heterogeneous catalyst systems typically are referred to as Ziegler-Natta catalysts. The disadvantage of many Ziegler-Natta catalysts is that it is difficult to control the physical properties of the resulting polymer, and the activity typically is much lower than the activity of the metallocene catalysts. Neither Ziegler-Natta catalyst alone or metallocene catalysts alone are capable of making satisfactory polyolefins having a bimodal molecular weight distribution or a broad molecular weight distribution.

The art recently has recognized a method of making bimodal resin by using a mixed hybrid catalyst system containing Ziegler-Natta and metallocene catalyst components. These mixed, or hybrid, catalyst systems typically comprise a combination of a heterogeneous Ziegler-Natta catalyst and a homogenous metallocene catalyst. These mixed systems can be used to prepare polyolefins having broad molecular weight distribution or bimodal polyolefins, and they provide a means to control the molecular weight distribution and polydispersity of the polyolefin.

W.O Pat. 9513871, and U.S. Pat. No. 5,539,076 disclose a mixed metallocene/non-metallocene catalyst system to produce a specific bimodal, high density copolymer. The catalyst system disclosed therein is supported on an inorganic support. Other documents disclosing mixed Ziegler-Natta/metallocene catalyst on a support such as silica, alumina, magnesium-chloride and the like include, W.O. Pat. 9802245, U.S. Pat. 5,183,867, E.P Pat.0676418A1, EP 717755B1, U.S. Pat. 5,747,405, E.P. Pat. 0705848A2, U.S. Pat. 4,659,685, U.S. Pat. 5,395,810, E.P. Pat. 0747402A1, U.S. Pat. 5,266,544, and W.O. 9613532, the disclosures of which are incorporated herein by reference in their entirety.

Supported Ziegler-Natta and metallocene systems suffer from many drawbacks, one of which is an attendant loss of activity due to the bulky support material. Delivery of liquid, unsupported catalysts to a gas phase reactor was first described in Brady et al., U.S. Pat. No. 5,317,036, the disclosure of which is incorporated herein by reference in its entirety. Brady recognized disadvantages of supported catalysts including, inter alia, the presence of ash, or residual support material in the polymer which increases the impurity level of the polymer, and a deleterious effect on catalyst activity because not all of the available surface area of the catalyst comes into contact with the reactants. Brady further described a number of advantages attributable to delivering a catalyst to the gas phase reactor in liquid form. Brady did not appreciate, however, that a self-supported mixed Ziegler-Natta/metallocene catalyst could be used to form a polyolefin in a single reactor having a broad molecular weight distribution or a bimodal molecular weight distribution.

Another problem associated with the prior art supported hybrid catalysts is that the the supported hybrid catalysts often had activities lower than the activity of the homogeneous catalyst alone. Finally, it is difficult to specifically tailor the properties of the resulting polyolefin using supported hybrid catalyst systems.

The prior art mixed supported catalysts also produced polymer, albeit in a single reactor, that essentially contained high molecular weight granules and low molecular weight granules. The problems discussed above that are associated with blending two different polymer particles, are also present in these systems. Moreover, producing different granules of polymers in a single reactor leads to poor reactor control, poor morphology of the resulting polymer, difficulties in compounding and difficulties in pelleting the resultant polymer. Finally, it is difficult to ensure adequate mixing of the two polymer components which raises a number of quality control issues.

### SUMMARY OF THE INVENTION

There exists a need to maximize the benefits of each individual catalyst system (i.e., Ziegler-Natta and metallocene) without suffering a penalty in terms of activity of the catalyst components, and without suffering from the poor reactor control and poor product quality control discussed above. There also exists a need to produce bimodal products having excellent product strength and processability. There also exists a need to develop a catalyst to produce such bimodal polyolefins without suffering from the above-noted problems. It would be desirable to produce polymer granules in a single reactor whereby the granules contain a high molecular weight component and a low molecular weight component.

It is therefore a feature of the present invention to provide a catalyst system that is capable of producing a polyolefin with a broad molecular weight distribution, or a bimodal molecular weight distribution in a single reactor. It is an additional feature of the invention to provide a catalyst, a method of making the catalyst and a method of making a bimodal polyolefin using the catalyst that does not suffer from the drawbacks mentioned above. IT is yet another feature of the invention to provide a catalyst system that is capable of producing polyolefin granules that contain a high molecular weight component and a low molecular weight component.

In accordance with these and other features of the present invention, there is provided a hybrid catalyst for the polymerization of olefin monomers comprising a self-supported hybrid catalyst containing a Ziegler-Natta component and a metallocene component affixed to the Ziegler-Natta component, whereby the Ziegler-Natta component comprises a solid complex containing at least magnesium, transition metal, and alkoxide moieties, where the transition metal is selected from the group consisting of one or more metals having an oxidation state of +3,+4,+5, and mixtures thereof.

In accordance with an additional feature of the present invention, there is provided a method of making a self-supported hybrid catalyst containing a Ziegler-Natta component and a metallocene component comprising dissolving the metallocene component in a suitable solvent, and then adding the solid Ziegler-Natta component, mixing the two components together and removing the solvent to yield a solid self-supported hybrid catalyst.

In accordance with an additional feature of the present invention, there is provided a method of making a broad molecular weight or bimodal polyolefin comprising contacting at least one olefin monomer with a self-supported hybrid catalyst containing a Ziegler-Natta component and a metallocene component under polymerization conditions. These and other features of the invention readily apparent to those skilled in the art can be achieved by reference to the detailed description that follows.

### BRIEF DESCRIPTION OF THE DRAWINGS

FIG. 1 is a size exclusion chromatography (SEC) representation of the molecular weight distribution of the polymer produced in accordance with example 6, sample C′.

FIG. 2 is a size exclusion chromatography (SEC) representation of the molecular weight distribution of the polymer produced in accordance with example 6, sample B.

### DETAILED DESCRIPTION OF PREFERRED EMBODIMENTS

Throughout this description, the expression “self-supported hybrid catalyst” denotes a hybrid catalyst containing a Ziegler-Natta catalyst component and a metallocene component, but does not contain conventional inorganic supports such as silica, alumina, silica-alumina, magnesium chloride, and the like. Rather, the Ziegler-Natta component of the inventive catalyst serves as a support itself, thereby rendering the hybrid catalyst “self-supported.” Catalyst performance can be optimized by choice of metallocene component, its ratio to the Ziegler-Natta component, and the cocatalyst.

Throughout this description, the expression “affixed to,” insofar as it relates to the metallocene component being “affixed to” the Ziegler-Natta component, denotes the metallocene component and the Ziegler-Natta component being in intimate contact with one another preferably without the use of an adhesion promoter, and preferably without chemical bonding agents. It is preferred that the metallocene component forms a coating-like layer over the Ziegler-Natta component and the two catalyst components remain affixed to one another as a solid self-supported hybrid catalyst. Preferably, the two catalyst components remain affixed to one another during feeding to the polymerization reactor, and most preferably, the two catalyst components remain affixed to one another during polymerization to form polymer granules that contain an intimate mixture of a high molecular weight component and a low molecular weight component.

Throughout this description, the expression “removing the solvent,” insofar as it relates to removing the solvent during preparation of the solid self-supported hybrid catalyst, denotes removing a substantial amount of the solvent to form a solid catalyst. Minor amounts of residual solvent may remain in the solid self-supported hybrid catalyst so long as a solid material is formed whereby the metallocene component and the Ziegler-Natta component are affixed to one another.

The self-supported hybrid catalyst system of the present invention is useful in the polymerization of any polymer in which separate polymerizations with a homogeneous catalyst and with a heterogeneous catalyst are possible. Preferably, the self-supported hybrid catalyst system is useful in the polymerization of olefins, more preferably, α-olefins, and, most preferably, ethylene and propylene. The alpha olefin polymer resins may be homopolymers, copolymers or admixtures of homopolymers and copolymers. Copolymers of ethylene preferably contain at least 70 weight percent ethylene and an alpha olefin of 3 to 10 carbon atoms. Preferred alpha olefins include propylene, 1-butene, 1-hexene, 1-octene and 4 methyl-pentene. Copolymers of propylene typically contain at least 65 weight percent propylene an alpha olefin of ethylene or one having 4 to 10 carbon atoms. Again, preferred alpha olefins include 1-butene, 1-hexene, 1-octene and 4 methyl-pentene.

The broad molecular weight or bimodal polyolefin resins produced using the hybrid catalyst system of the invention can have any density normally attributable to such resins. Usually, the resins have a specific density in the range of 0.86 to 0.970. The polyethylene resins (homo- or copolymers) which can be produced in accordance with the invention can exhibit densities of high density, medium density or low density resins, respectively. Accordingly, the resins can be produced which exhibit specific density in the range of 0.89 to 0.92 for low density, 0.930 to 0.940 for medium density, and 0.940 to 0.970 for high density. The polyolefin resins of the invention include, for example, ethylene homopolymers and copolymers of ethylene and one or more higher alpha-olefins such as propylene, 1-butene, 1-pentene, 1-hexene, 4-methyl-1-pentene, and 1-octene. Polyolefin resins also include, for example, ethylene/propylene rubbers (EPR's), ethylene/propylene/diene terpolymers (EPDM's) and the like.

The broad molecular weight or bimodal polyolefin resin usually has a molecular weight distribution which is characterized as the melt flow ratio (MFR) or as the weight average molecular weight divided by the number average molecular weight (Mw/Mn). The MFR of the broad molecular weight or bimodal polyolefin resins of the invention can range anywhere from about 30 to about 500, preferably from about 50 to about 300, and most preferably from about 70 to about 200, whereby the MFR is the ratio of I21.6 (also referred to as the flow index) divided by I2.16 (also referred to as the melt index). 121.6 and I2.16 are measured in accordance with ASTM D1238, Condition E for the I2.16 of polyethylene and by condition F for the I21.6 of polyethylene and Condition L for polypropylene. The Mw/Mn of resin products of the invention can range anywhere from about 5 to about 75, preferably from about 7 to about 50, and most preferably from about 8 to about 40.

The broad molecular weight or bimodal polyolefin resin prepared in accordance with the present invention usually has a flow index within the range of from about 1 to about 130, preferably from about 1.5 to about 50 and most preferably from about 2 to about 40. The broad molecular weight or bimodal polyolefin resin prepared in accordance with the present invention also typically will have a bulk density within the range of from about 15 to about 50, preferably from about 20 to about 40, and most preferably from about 20 to about 30. The resin of the invention also usually has a weight average molecular weight within the range of from about 0.5×10⁵ to about 10×10⁵, preferably from about 0.8×10⁵ to about 8×10⁵, and most preferably from about 1.0×10⁵ to about 6×10⁵. In addition, the resin of the invention typically has a number average molecular weight within the range of from about 0.5×10⁴ to about 2.0×10⁵, preferably from about 0.8×10⁴ to about 1×10⁵, and most preferably from about 1×10⁴ to about 5×10⁴.

By using the self-supported hybrid catalyst of the invention having at least one metallocene (i.e., homogeneous) catalyst and at least one Ziegler-Natta (i.e., heterogeneous) catalyst component, a polyolefin can be produced with a broad molecular weight distribution (MWD). The MWD can be represented by a chart of gel permeation chromatography (GPC) or determined using scanning electron calorimetry (SEC). These techniques are well known in the art, and skilled artisans are capable of determining the MWD of polyolefins made in accordance with the present invention using the guidelines provided herein.

The metallocene catalyst component, when used alone, will usually produce a polymer with a MWD which is narrow relative to a polymer produced by a Ziegler-Natta catalyst component alone. For example, using a heterogeneous Ziegler-Natta catalyst alone typically produces a polymer with a MWD of approximately 5-10, and using a homogeneous metallocene catalyst alone typically produces a MWD of approximately 2-3.5. The present inventors have found that when using the inventive hybrid self-supported catalyst, a polymer having a MWD of greater than 10 can be produced.

The inventors also have found that the polydispersity, i.e., the distribution of molecular weights, can be affected by using different ratios of the catalyst components. Since the molecular weight of the polymer produced with the homogeneous catalyst is different from the molecular weight of the polymer produced using the heterogeneous catalyst, changing the relative amount of one catalyst to the other in the hybrid self-supported catalyst system of this invention will change the polydispersity of the polymer produced. Using the guidelines provided herein including the examples, skilled artisans are capable of modifying the ratio of catalyst components to specifically tailor a polyolefin resin product.

The self-supported hybrid catalyst of the present invention preferably is useful in producing a high molecular weight, high density bimodal polyolefin product. The catalyst usually is a hybrid catalyst comprising a self-supported hybrid catalyst containing a Ziegler-Natta component and a metallocene component that is affixed to the Ziegler-Natta component, whereby the Ziegler-Natta component comprises a solid complex containing at least magnesium, transition metal, and alkoxide moieties, where the transition metal is selected from the group consisting of one or more metals having an oxidation state of +3, +4,+5, and mixtures thereof. Preferably, the Ziegler-Natta component comprises a solid product resulting from contacting a complex magnesium-containing, transition metal-containing (preferably, a titanium-containing) alkoxide compound with alkyl aluminum halide. The metallocene component preferably is any metallocene having cyclopentadiene ligands that can be substituted and/or bridged. Combinations of different metallocene components and Ziegler-Natta components can lead to versatile catalyst compositions that can be used to produce distinct polyolefin products.

The Ziegler-Natta component of the hybrid catalyst system is self-supported and does not require extraneous supports such as magnesium chloride, silica, alumina, and the like. Preferably, the Ziegler-Natta component is a solid magnesium and titanium-containing component, whereby some or all of the titanium can be replaced by other transition metals. Most preferably, the Ziegler-Natta component is a solid magnesium and titanium-containing complex. The Ziegler-Natta component typically is prepared by halogenating a solid precursor material that contains magnesium and titanium to prepare a solid procatalyst. Throughout this description the term “precursor” and the expression “procatalyst precursor” denote a solid material that is not an active catalyst component, and that contains magnesium and titanium, and which can be converted to a “procatalyst” (defined below) by contacting it with any suitable halogenating agent such as alkylaluminum halide or tetravalent titanium halide (preferably TiCl₄) and optionally an electron donor. Throughout this description, the term “procatalyst” denotes a solid material that is an active catalyst component, and that can be converted to a polymerization catalyst by contact with an organoaluminum compound (preferably triethyl aluminum (TEAL)), and an optional external donor, or selectivity control agent.

Any unsupported magnesium and titanium containing precursor can be used in the present invention, and any means known to halogenate such a precursor can be used to prepare a solid procatalyst. A number of United States patents issued to Robert C. Job (and Robert C. Job, et al.,) describe various magnesium and titanium containing precursors useful for the production of procatalysts that are ultimately useful in preparing catalysts for the polymerization of α-olefins. For example, U.S. Pat. Nos. 5,034,361; 5,082,907; 5,151,399; 5,229,342; 5,106,806; 5,146,028; 5,066,737; 5,124,298, and 5,077,357, the disclosures of which are incorporated by reference herein in their entirety, disclose various procatalyst precursors. Any of the precursors described therein can be used in the present invention.

When magnesium alkoxides, such as magnesium ethoxide, are used as the starting materials to form the procatalyst precursor, a clipping agent usually is needed to break up the polymeric magnesium ethoxide and allow its reaction with the other components. As disclosed in U.S. Pat. Nos. 5,124,298 and 5,077,357, the precursor can be prepared by using chlorobenzene as a solvent and o-cresol as a clipping agent to chemically break down the polymeric magnesium ethoxide. Other clipping agents include, inter alia, 3-methoxyphenol, 4-dimethylaminophenol, 2,6-di-tert-butyl-4-methylphenol, p-chlorophenol, HCHO, CO₂, B(OEt)₃, SO₂, Al(OEt)₃, CO₃^{═}, Br⁻, (O₂COEt)⁻, Si(OR)₄, R′Si(OR)₃, and P(OR)₃. In the above compounds, R and R′ represent hydrocarbon groups, preferably alkyl groups, containing from 1-10 carbon atoms, and preferably R and R′ are the same or different and are methyl or ethyl. Other agents that release large anions or form large anions in situ (i.e., clipping agent precursors) can be used, such as MgBr₂, carbonized magnesium ethoxide (magnesium ethyl carbonate), calcium carbonate, and the like. Phenolic compounds such as p-cresol, 3-methoxyphenol, 4-dimethylaminophenol, etc., certain agents are known to dissolve magnesium alkoxides such as magnesium ethoxide, but these agents typically are employed in very large excess and usually in the presence of aliphatic, aromatic and/or halogenated hydrocarbon solvents.

Any of the solid magnesium containing procatalysts, and the methods for preparing them that are disclosed in U.S. patent application Ser. Nos. 09/345,082, 09/395,924, 09/395,916, and 09/395,917 can be used in the present invention. The disclosure of each of these applications is incorporated by reference herein in its entirety.

It is preferred that the Ziegler-Natta component contain magnesium, transition metal, and alkoxide moieties. Useful catalysts include mixed metal alkoxide complexes containing, as the mixed metal portion, Mgₓ(T1T2)_{y} where T1 and T2 may be the same or different and are selected from one or more metals having oxidation states of +3,+4 and +5, and wherein the molar ratio of x/y is from about 2.5 to about 3.75. The mixed metal alkoxide complex may have, complexed to the mixed metal portion, at least one group selected from alkoxide groups, phenoxide groups, halides, hydroxy groups, carboxyl groups and amide groups.

It is preferred in the present invention that T1 and T2 are one or more metals selected from the group consisting of Ti (Ti⁺³ and Ti⁺⁴), Zr, V (V⁺⁴ and V⁺⁵), Sm, Fe, Sn and Hf, and mixtures thereof, more preferably T1 and T2 are selected from Ti and Zr, and most preferably T1 and T2 are titanium. The molar ratio of the Mg metal to the T1 and T2 metals, (i.e., the ratio of x/y) preferably is within the range of from 2.5 to 3.75, more preferably within the range of from 2.7 to 3.5 and most preferably, the molar ratio is 3. It also is preferred that alkoxide groups and halide groups are complexed to the mixed metal portion of the mixed metal alkoxide complex.

The mixed metal alkoxide complex can be made by any method capable of forming a complex between the mixture of metals, and the additional complexing groups, at least one of which is selected from alkoxide groups, phenoxide groups, halides, hydroxy groups, carboxyl groups and amide groups. Preferably, the precursor is prepared by contacting a mixture of magnesium alkoxides, halides, carboxyls, amides, phenoxides or hydroxides with a mixture of T1 and T2 metal alkoxides, halides, carboxyls, amides, phenoxides or hydroxides to form a solid precursor complex, and then separating the solid complex from the mixture. In accordance with this method, a clipping agent preferably is used and, optionally, an aliphatic alcohol can be used to form the solid precursor complex. In addition, a halide can be used during the preparation of the mixed metal alkoxide precursor complex, preferably a chloride, and most preferably, TiCl₄. This precursor complex then can be converted to a procatalyst component by halogenation using any means known to those skilled in the art. The final product is the Ziegler-Natta component useful in forming the hybrid catalyst of the invention.

It is especially preferred in the present invention to use a Ziegler-Natta component that can be activated using MAO or MMAO as a cocatalyst, and which makes a broad MWD high molecular weight polymer. It also is preferred in the invention to use a Ziegler-Natta component that produces a polymer having enhanced film and film-forming attributes. The Ziegler-Natta component most preferably is prepared by contacting magnesium ethoxide, a halogenated aromatic solvent, a clipping agent such as o-cresol, and titanium ethoxide to form a solid precursor material. The solid precursor material then is converted to a procatalyst by halogenation first with a mixture of silicon tetrachloride and titanium tetrachloride, and then with ethylaluminum dichloride, and then with boron trichloride. Such a Ziegler-Natta component provides an excellent support for the metallocene component.

Any metallocene component useful in polymerizing olefins can be used in the present invention. For example, any of the metallocenes disclosed in U.S. Pat. No. 5,693,727, the disclosure of which is incorporated by reference herein in its entirety can be used in the present invention. Preferred metallocenes include dimethylsilyl (biscyclopentadiene) zirconium dichloride (DMSBZ), bis(n-butylcyclopentadiene) zirconium dichloride (BuCpZ), dimethylsilyl (bis(n-propylcyclopentadiene)) zirconium dichloride (DMSPrCpZ), bis(n-propylcyclopentadiene)) zirconium dichloride (PrCpZ) and (cyclopentadiene) (indenyl) zirconium dichloride. Most preferred is DMSBZ.

The hybrid Ziegler-Natta/metallocene procatalyst of the invention can be prepared in any manner capable of affixing the selected metallocene(s) component to the selected Ziegler-Natta component(s). Initially, the respective Ziegler-Natta and metallocene components are prepared separately using techniques known in the art, including those described above. Preferably, a Ziegler-Natta precursor is prepared, then halogenated to form a procatalyst, and the metallocene catalyst is prepared separately from the Ziegler-Natta procatalyst. Skilled artisans are capable of making Ziegler-Natta and metallocenes useful in the present invention using the guidelines provided herein.

It is preferred in the present invention to prepare the hybrid procatalyst by first dissolving the metallocene component(s) in a suitable solvent, and then adding the Ziegler-Natta procatalyst(s) (s) as a solid to the solution. Volatiles then can be removed from the solution by, inter alia, evaporation, vacuum distillation, etc., and the solid hybrid catalyst retrieved. By removing the volatiles from the solution, the metallocene is effectively affixed to the Ziegler-Natta component, which acts as a support, as well as a heterogeneous catalyst.

While not intending to be bound by any theory, it is believed that affixing the metallocene component to the Ziegler-Natta component provides a solid complex whereby the interaction between the individual components is strong enough to allow the hybrid catalyst to substantially remain intact during conventional polymerization conditions. It also is preferred that the interaction between the respective components be strong enough to allow the hybrid catalyst to substantially remain intact when the catalyst is suspended in, for example, mineral oil and the like. If this were not the case, one would expect the two components to break apart from each other and then function merely as a mixture of the two. While not intending to be bound by any theory, the present inventors believe that affixing the metallocene component to the Ziegler-Natta component provides polymer particles that have both high and low molecular weight components interdispersed with each other. In stark contrast to the present invention, conventional mixtures of Ziegler-Natta and metallocene catalysts produce high molecular weight polymer particles and low molecular weight polymer particles that must be subsequently compounded and mixed. Because the self-supported hybrid catalyst of the invention is capable of making polymer particles having both high and low molecular weight components, the inventors believe that the Ziegler-Natta and metallocene components remain in contact with each other, and behave synergistically, during polymerization.

Any solvent can be used in the invention so long as it is capable of dissolving the metallocene component(s). The solvents which can be utilized include inert solvents, preferably non-functional hydrocarbon solvents, and may include aliphatic hydrocarbons such as butane, isobutane, ethane, propane, pentane, isopentane, hexane, heptane, octane, decane, dodecane, hexadecane, octadecane, and the like; alicyclic hydrocarbons such as cyclopentane, methylcyclopentane, cyclohexane, cycloctane, norbornane, ethylcyclohexane and the like; aromatic hydrocarbons such as benzene, toluene, ethylbenzene, propylbenzene, butylbenzene, xylene, tetrahydrofuran and the like; petroleum fractions such as gasoline, kerosene, light oils, and the like; and mineral oil. Likewise, halogenated hydrocarbons such as methylene chloride, chlorobenzene, ortho-chlorotoluene and the like may also be utilized. By “inert” is meant that the material being referred to is non-deactivating in the polymerization reaction zone under the conditions of gas phase polymerization and is non-deactivating with the catalyst in or out of the reaction zone. By “non-functional”, it is meant that the solvents do not contain groups such as strong polar groups which can deactivate the active catalyst metal sites.

The synthesis of the hybrid Ziegler-metallocene catalyst preferably can be carried out by dissolving a pre-determined amount of metallocene in a minimal volume of a suitable solvent. Those skilled in the art, using the guidelines provided herein, can determine the amount of metallocene needed, as well as the amount of solvent required to dissolve it. The Ziegler-Natta component then can be added as a solid to the solution, and the volatiles are removed. The ratio of metallocene component to the Ziegler-Natta component can vary within wide limits, and is determined by the desired product properties of the resins. For example, if a greater amount of a low molecular weight component having a narrow MWD is desired, then more metallocene can be used. In a similar vein, if a greater amount of a higher molecular weight component having a broader MWD is desired, then more of the Ziegler-Natta component can be used. Skilled artisans are capable of modifying the ratio of the respective metallocene and Ziegler-Natta components to produce desired product properties, using the guidelines provided herein.

The ratio of mmol Ti in the Ziegler-Natta component to mmol Zr in the metallocene component can range anywhere from 0.1 to 100, and preferably is between 0.5 and 10. Preferably, the procedure of making the inventive hybrid catalyst component is carried out under an inert atmosphere such as dinitrogen or argon. The volume of the solvent is chosen so that it is sufficient to dissolve the metallocene, while at the same time wet the solid Ziegler component. Any solvents which dissolve the metallocene can be used for this process. Such solvents preferably include aromatics such as toluene, chlorobenzene, and xylene; alkanes such as hexane and pentane and alkyl chlorides such as methylene chloride and chloroform. Solvents with polar groups such as acetonitrile, tetrahydrofuran and dioxane are least preferred. Most preferably, the solvent is methylene chloride, hexane or toluene.

It is preferred in the present invention that the duration of contact between the solid Ziegler-Natta component and the solution of the metallocene component can range anywhere from about 1 minute to about 48 hours. More preferably the time of contact is between about 2 minutes to about 24 hours, and most preferably, the time of contact is between about 3 minutes to about 15 minutes. The volatiles can be removed by any technique known in the art that is capable of removing volatiles from a solution. Preferably, the volatiles are removed by placing the mixture under a vacuum source, boiling off the solvent or purging it off using an inert gas stream such as dinitrogen or argon.

The hybrid Ziegler-Natta/metallocene procatalyst of the invention serves as one component of a polymerization catalyst system where it is contacted with a cocatalyst and optionally, a selectivity control agent. Any cocatlyst typically used in the polymerization of olefins using metallocene catalysts can be used with the hybrid Ziegler-Natta/metallocene catalyst of the invention. While certain cocatalysts typically employed with Ziegler-Natta procatalysts can be detrimental to the activity of metallocenes, (e.g., triethyl aluminum), trimethyl aluminum (TMA) may be used as a cocatalyst with the inventive hybrid Ziegler-Natta/metallocene catalyst, although aluminoxanes are preferred.

Aluminum-containing activating cocatalysts typically used with metallocene catalysts include the conventional aluminoxane compounds. Illustrative aluminoxane compounds include methylaluminoxane (MAO) or modified methylaluminoxane (MMAO). Aluminoxanes are well known in the art and comprise oligomeric linear alkyl aluminoxanes represented by the formula:

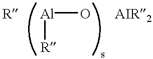

and oligomeric cyclic alkyl aluminoxanes of the formula:

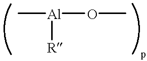

wherein s is 1-40, preferably 10-20; p is 3-40, preferably 3-20; and R″ is an alkyl group containing 1 to 12 carbon atoms, preferably methyl or an aryl radical such as a substituted or unsubstituted phenyl or naphthyl radical.

Aluminoxanes may be prepared in a variety of ways. Generally, a mixture of linear and cyclic aluminoxanes is obtained in the preparation of aluminoxanes from, for example, trimethylaluminum and water. For example, an aluminum alkyl may be treated with water in the form of a moist solvent. Alternatively, an aluminum alkyl, such as trimethylaluminum, may be contacted with a hydrated salt, such as hydrated ferrous sulfate. The latter method comprises treating a dilute solution of trimethylaluminum in, for example, toluene with a suspension of ferrous sulfate heptahydrate. It is also possible to form methylaluminoxanes by the reaction of a tetraalkyl-dialuminoxane containing C₂ or higher alkyl groups with an amount of trimethylaluminum that is less than a stoichiometric excess. The synthesis of methylaluminoxanes may also be achieved by the reaction of a trialkyl aluminum compound or a tetraalkyldialuminoxane containing C₂ or higher alkyl groups with water to form a polyalkyl aluminoxane, which is then reacted with trimethylaluminum. Further modified methylaluminoxanes, which contain both methyl groups and higher alkyl groups, may be synthesized by the reaction of a polyalkyl aluminoxane containing C₂ or higher alkyl groups with trimethylaluminum and then with water as disclosed in, for example, U.S. Pat. No. 5,041,584.

Preferred cocatalysts are aluminoxanes, with modified methyl aluminoxane (MMAO) being the most preferred.

The amount of hybrid catalysts and aluminum-containing activating cocatalyst employed in the catalyst composition can determine the split of the molecular weight distribution of the polyolefin. The term “split” denotes the relative amount of low molecular weight component to the high molecular weight component in the resulting polyolefin. By adjusting the mole ratio of total aluminum atoms contained in the aluminum-containing activating cocatalyst to the total of titanium and zirconium atoms contained in the hybrid catalyst one is able to fine tune the molecular weight distribution of the bimodal or multi-modal polyolefin. For example, it generally is known that metallocene catalysts require more aluminum-containing activating cocatlyst. Thus, decreasing the amount of aluminum can serve to decrease the amount of particular polymer component made by the metallocene portion of the inventive hybrid catalyst, and hence, affect the MWD of the resulting polyolefin. To broaden the molecular weight distribution of the polyolefin, the aluminum/(transition metal) mole ratio can be increased. To narrow the molecular weight distribution of the polyolefin, the aluminum/(transition metal) mole ratio can be decreased. Using the guidelines provided herein, those skilled in the art are capable of modifying the aluminum/transition metal mole ratio to specifically tailor a polymer having a desired MWD.

Overall useful aluminum/(transition metal) mole ratios in the hybrid catalyst composition generally range from about 2:1 to about 100,000:1, preferably from about 10:1 to about 10,000:1, and most preferably from about 200:1 to about 1,000:1. It is preferred in the present invention that the Al:Ti ratio be within the range of from about 200:1 to about 1,000:1, and that the Al:Zr ratio be greater than about 50:1, most preferably about 1000:1.

When propylene is polymerized, the hybrid catalyst system will also typically employ an external electron donor. The electron donor may be one of the electron donors which are effective with Ziegler-Natta and/or metallocene catalysts in producing polypropylene homopolymers or copolymers. Typically, the electron donor is an organosilicon compound. Examples of suitable electron donors useful in the present invention are methyl cyclohexyl dimethoxysilane (MCHDMS), diphenyldimethoxysilane (DPDMS), dicyclopentyl dimethoxysilane (DCPDMS), isobutyltrimethoxysilane (IBTMS), and n-propyl trimethoxysilane (NPTMS). Other examples of electron donors are disclosed in U.S. Pat. Nos. 4,218,339; 4,395,360; 4,328,122; 4,473,660; 4,562,173 and 4,547,552, each of which are hereby incorporated by reference in their entirety.

The hybrid Ziegler-Natta/metallocene olefin polymerization catalyst may be used in slurry, liquid phase, gas phase and liquid monomer-type reaction systems as are known in the art for polymerizing olefins. Polymerization preferably is conducted in a fluidized bed polymerization reactor, however, by continuously contacting an alpha-olefin having 2 to 8 carbon atoms with the components of the catalyst system, i.e, the solid procatalyst component, cocatalyst and optional SCAs. In accordance with the process, discrete portions of the catalyst components can be continually fed to the reactor in catalytically effective amounts together with the alpha-olefin while the polymer product is continually removed during the continuous process. Fluidized bed reactors suitable for continuously polymerizing alpha-olefins have been previously described and are well known in the art. Fluidized bed reactors useful for this purpose are described, e.g., in U.S. Pat. Nos. 4,302,565, 4,302,566 and 4,303,771, the disclosures of which are incorporated herein by reference. Those skilled in the art are capable of carrying out a fluidized bed polymerization reaction using the guidelines provided herein.

It is preferred sometimes that such fluidized beds are operated using a recycle stream of unreacted monomer from the fluidized bed reactor. In this context, it is preferred to condense at least a portion of the recycle stream. Alternatively, condensation may be induced with a liquid solvent. This is known in the art as operating in “condensing mode.” Operating a fluidized bed reactor in condensing mode generally is known in the art and described in, for example, U.S. Pat. Nos. 4,543,399 and 4,588,790, the disclosures of which are incorporated by reference herein in their entirety. The use of condensing mode has been found to lower the amount of xylene solubles in isotactic polypropylene and improve catalyst performance when using the catalyst of the present invention.

The catalyst composition may be used for the polymerization of olefins by any suspension, solution, slurry, or gas phase process, using known equipment and reaction conditions, and is not limited to any specific type of reaction system. Generally, olefin polymerization temperatures range from about 0° C. to about 200° C. at atmospheric, subatmospheric, or superatmospheric pressures. Slurry or solution polymerization processes may utilize subatmospheric or superatmospheric pressures and temperatures in the range of about 40° C. to about 110° C. A useful liquid phase polymerization reaction system is described in U.S. Pat. No. 3,324,095. Liquid phase reaction systems generally comprise a reactor vessel to which olefin monomer and catalyst composition are added, and which contains a liquid reaction medium for dissolving or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isopentane, hexane, cyclohexane, heptane, benzene, toluene, and the like. Reactive contact between the olefin monomer and the catalyst composition should be maintained by constant stirring or agitation. The reaction medium containing the olefin polymer product and unreacted olefin monomer is withdrawn from the reactor continuously. The olefin polymer product is separated, and the unreacted olefin monomer and liquid reaction medium are recycled into the reactor.

Preferably, gas phase polymerization is employed, with superatmospheric pressures in the range of 1 to 1000, preferably 50 to 400 psi, most preferably 100 to 300 psi, and temperatures in the range of 30 to 130° C., preferably 65 to 110° C. Stirred or fluidized bed gas phase reaction systems are particularly useful. Generally, a conventional gas phase, fluidized bed process is conducted by passing a stream containing one or more olefin monomers continuously through a fluidized bed reactor under reaction conditions and in the presence of catalyst composition at a velocity sufficient to maintain a bed of solid particles in a suspended condition. A stream containing unreacted monomer is withdrawn from the reactor continuously, compressed, cooled, optionally fully or partially condensed as disclosed in U.S. Pat. Nos. 4,528,790 and 5,462,999, and recycled to the reactor. Product is withdrawn from the reactor and make-up monomer is added to the recycle stream. As desired for temperature control of the system, any gas inert to the catalyst composition and reactants may also be present in the gas stream. In addition, a fluidization aid such as carbon black, silica, clay, or talc may be used, as disclosed in U.S. Pat. No. 4,994,534.

Polymerization may be carried out in a single reactor or in two or more reactors in series, and is conducted substantially in the absence of catalyst poisons. Organometallic compounds may be employed as scavenging agents for poisons to increase the catalyst activity. Examples of scavenging agents are metal alkyls, preferably aluminum alkyls, most preferably triisobutylaluminum.

The precise procedures and conditions of the polymerization are broadly conventional but the olefin polymerization process, by virtue of the use therein of the polymerization catalyst formed from the solid precursor, provides polyolefin product having a relatively high bulk density in quantities that reflect the relatively high productivity of the olefin polymerization catalyst. In addition, the polymeric products produced in the present invention have a reduced level of fines.

Conventional additives may be included in the process, provided they do not interfere with the operation of the catalyst composition in forming the desired polyolefin. When hydrogen is used as a chain transfer agent in the process, it is used in amounts varying between about 0.001 to about 10 moles of hydrogen per mole of total monomer feed. Also, as desired for temperature control of the system, any gas inert to the catalyst composition and reactants can also be present in the gas stream.

The polymerization product of the present invention can be any product, homopolymer, copolymer, terpolymer, and the like. Usually, the polymerization product is a homopolymer such as polyethylene or polypropylene, particularly polypropylene. Alternatively, the catalyst and process of the invention are useful in the production of copolymers including copolymers of ethylene and propylene such as EPR and polypropylene impact copolymers when two or more olefin monomers are supplied to the polymerization process. Those skilled in the art are capable of carrying out suitable polymerization of homopolymers, copolymers, terpolymers, etc., using liquid, slurry or gas phase reaction conditions, using the guidelines provided herein.

The invention now will be explained by reference to the non-limiting examples noted below.

### EXAMPLES

The following defined terms will be used in the examples.

### Glossary

Density in g/ml was determined in accordance with ASTM 1505, based on ASTM D-1928, procedure C, plaque preparation. A plaque was made and conditioned for one hour at 100° C. to approach equilibrium crystallinity, measurement for density was then made in a density gradient column.

BuCpZ is 1.1′-bis-n-butylcyclopentadienyl zirconium dichloride, commercially available from Witco Corporation ((BuCP)₂ZrCl₂).

PrCpZ is bis(n-propylcyclopentadiene)zirconium dichloride.

DMSBZ is dimethylsilyl(biscyclopentadiene)zirconium dichloride.

DMSPrCpZ is dimethylsilyl(bis(n-propylcyclopentadiene)) zirconium dichloride.

MMAO is a solution of modified methyl aluminoxane (type 3A) in heptane, approximately 2.3 molar in aluminum, available from Akzo Corporation.

PDI stands for Polydispersity Index, which is equivalent to Molecular Weight Distribution (M_{w}/Mₙ). PDI was determined by gel permeation chromatography using crosslinked polystyrene columns; pore size sequence: 1 column less than 1000 Å, 3 columns of mixed 5×10⁷ Å; 1,2,4-trichlorobenzene solvent at 140° C. with refractive index detection.

FI is the flow index (optionally termed I₂₁), reported as grams per 10 minutes, determined in accordance with ASTM D-1238 condition F, and was measured at ten times the weight used in the melt index test.

MFR is the melt flow ratio, which is the ratio of flow index to melt index. It is related to the molecular weight distribution of the polymer.

Activity is given in g polymer/mmol Ti/hour/100 psi ethylene.

Preparation of the Ziegler-Natta component.

Magnesium ethoxide (8.6 g, 75 mmol) was slurried into 100 g of chlorobenzene (90 ml), in an 8 ounce bottle, then 0.40 g o-cresol (3.75 mmol) was added. After stirring for about one (1) minute, 4.11 g of titanium ethoxide (95%, 17.1 mmol) and 1.97 g of titanium tetrachloride (10.4 mmol) were added. The bottle was placed in a 100° oil bath, and then a mixture of 4.5 ml of ethanol (3.53 g, 76.6 mmol) and 1.5 ml of butanol (1.21 g, 16 mmol) was quickly added. After stirring for 95 minutes at 440 rpm, the reaction appeared as a slightly cloudy solution with only a few granules of starting material remaining. The cap was removed and a gentle stream of nitrogen was passed for an hour (the liquid volume had decreased by approximately 7%). The slurry was transferred to a glove box and filtered warm. The solids were washed once with chlorobenzene, and then twice with hexane and dried under moving nitrogen. Yield: 10.8 g of off-white powder precursor material consisting mostly of 35 μ spheroids with a small group of 15 μm particles.

To a 10 gal stainless steel reaction/filter vessel were charged 1892 g of the off-white powder precursor material prepared above, along with 3.5 kg of hexane. Then, a solution containing about 3.9 kg silicon tetrachloride and 713 g titanium tetrachloride in 6.6 kg of toluene was charged at a rate to maintain the reaction temperature between 25 and 30° (15-20 minutes). The slurry was stirred for 30 minutes and then filtered through an internal filter plate. The solids were washed by reslurrying in 15 kg of a 50/50 mixture of hexane and toluene then isolated by filtration. In a like manner, the solids were then washed twice with hexane and dried under moving nitrogen. Yield: 2472 g of yellow powder. Analysis: 10.7% Mg, 9.82% Ti, 36.2% Cl. The reaction vessel was recharged with 1302 g of the yellow powder prepared above along with 5 kg of hexane. Then, 7291 g of 25% ethylaluminum dichloride/toluene was added at a rate to maintain the temperature between 25 and 30° (15 minutes). Then, 1175 g of 1 M boron trichloride/heptane was added all at once. After stirring for 30 minutes at 25°, the slurry was filtered. The solids were washed once with 50/50 hexane/toluene then twice with hexane and dried overnight under moving nitrogen. Yield: 1068 grams of dark red-brown powder which was the Ziegler-Natta procatalyst component. Analysis of the Ziegler-Natta procatalyst component revealed that it contained: 10.7% wt Mg, 9.62% wt Ti, 2.38% wt Al, 56.7% wt Cl. A polymerization sample was prepared by slurrying 0.100 g of Ziegler-Natta procatalyst component in 20 ml of Kaydol mineral oil.

Preparation of the Hybrid Ziegler-Natta/Metallocene Catalyst.

### Example 1

In a glove box, a round bottom flask was charged with 10 g dimethylsilyl (biscyclopentadiene)zirconium dichloride (DMSBZ), 300 cc methylene chloride and a stir bar. When the metallocene had dissolved, 50 g of the dark red-brown Ziegler-Natta procatalyst component were added to the solution as a solid. After stirring for about 3 minutes, the volatiles were removed in vacuo producing about 60 g of a dark red-brown powder hybrid catalyst designated as Sample A.

### Example 2

In a glove box, a round bottom flask was charged with 3 g DMSBZ, 150 cc methylene chloride and a stir bar. When the metallocene had dissolved, 5 g of dark red-brown Ziegler-Natta procatalyst component were added to the solution as a solid. After stirring for about 3 minutes, the volatiles were removed in vacuo to produce about 8 g of a red-brown powder hybrid catalyst designated as Sample B.

### Example 3

In a glove box, a round bottom flask was charged with 1 g of (bis(n-butylcyclopentadiene))zirconium dichioride (BuCpZ), 100 cc methylene chloride and a stir bar. When the metallocene had dissolved, about 10 g dark red-brown Ziegler-Natta procatalyst component were added to the solution as a solid. After stirring for about 3 minutes, the volatiles were removed in vacuo to produce about 11 g of a red-brown powder hybrid catalyst designated as Sample C.

The procedures of Example 3 were repeated except that 20 g of dark red-brown Ziegler-Natta procatalyst component were added to the solution as a solid. The hybrid catalyst was designated as Sample C′.

The procedures of Example 3 again were repeated except that 5 g of dark red-brown Ziegler-Natta procatalyst component were added to the solution as a solid. The hybrid catalyst was designated as Sample C″.

### Example 4

In a glove box, a round bottom flask was charged with 0.5 g of (dimethylsilylbis(n-propylcyclopentadiene))zirconium dichloride (DMSPrCpZ), 30 cc methylene chloride and a stir bar. When the metallocene had dissolved, 10 g dark red-brown Ziegler-Natta procatalyst component was added to the solution as a solid. After stirring for about 3 minutes, the volatiles were removed in vacuo giving a dark red-brown powder. Yield was 10.5 g of hybrid catalyst designated as Sample D.

### Example 5

In a glove box, a round bottom flask was charged with 100 mg of (dimethylsilylbis(n-propylcyclopentadiene))zirconium dichloride (DMSPrCpZ), 30 cc methylene chloride and a stir bar. When the metallocene had dissolved, 500 mg dark red-brown Ziegler-Natta procatalyst component was added to the solution as a solid. After stirring for about 3 minutes, the volatiles were removed in vacuo giving a free flowing, dark red-brown powder. Yield was 0.60 g of hybrid catalyst designated as Sample E.

### Example 6

In a glove box, a round bottom flask was charged with 100 mg of bis(n-propylcyclopentadiene)zirconium dichloride (PrCpZ), 30 cc methylene chloride and a stir bar. When the metallocene had dissolved, 500 mg dark red-brown Ziegler-Natta procatalyst component was added to the solution as a solid. After stirring for about 3 minutes, the volatiles were removed in vacuo giving a free flowing, dark red-brown powder. Yield was 0.60 g of hybrid catalyst designated as Sample F.

### Polymerization Using the Hybrid Catalyst Samples

Laboratory Slurry Reactor: HDPE

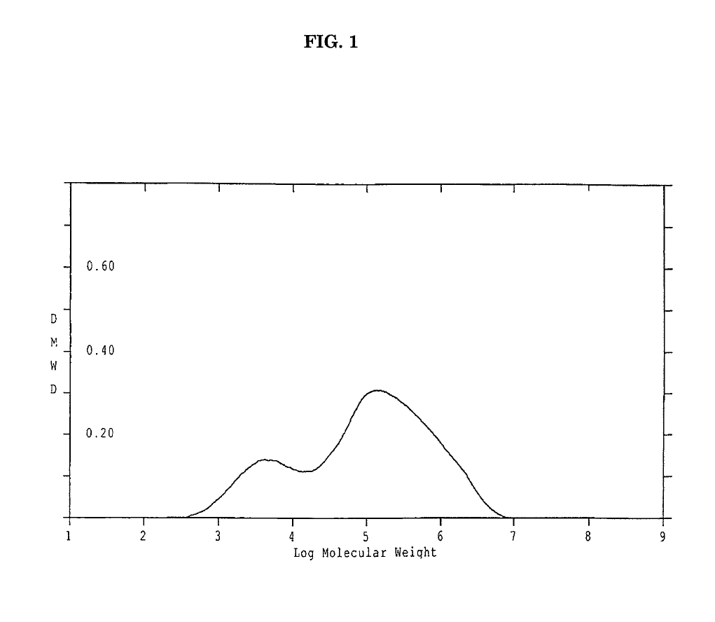

Catalysts were prepared according to the procedures described above, and are designated as Samples A-F. A 1 liter stirred autoclave reactor was charged with 485 cc hexane, 15 cc 1-hexene, about 500 equivalents/[Ti+Zr] of MMAO, and sufficient catalyst oil slurry of each of the Samples above to give a charge of 3 μmoles [Ti+Zr]. The reactor was pressurized with the desired volume of H₂ to achieve a desired flow index I21, and the temperature was raised to 70° C. Ethylene was fed to maintain a reactor pressure of 150 psig, and the temperature was controlled at 85° C. After 30 minutes, ethylene feed was stopped, the reactor was cooled and vented, and granular polyethylene was recovered. Results are given in Table 1. An SEC of the polymer produced in accordance with sample C′ is shown in FIG. 1.

TABLE 1

| Catalyst | Activity | Mn | Mw | PDI |
|---|---|---|---|---|
| Sample A | 58,387 | 0.168 × 10⁵ | 0.256 × 10⁶ | 15.3 |
| Sample B | 25,359 | 0.107 × 10⁵ | 0.257 × 10⁶ | 24.1 |
| Sample C′ | 45,484 | 0.109 × 10⁵ | 0.367 × 10⁶ | 33.7 |
| Sample C | 37,422 | 0.101 × 10⁵ | 0.234 × 10⁶ | 23.3 |
| Sample C″ | 31,002 | 0.111 × 10⁵ | 0.248 × 10⁶ | 22.3 |
| Sample E | 60,283 | 0.162 × 10⁵ | 0.284 × 10⁶ | 17.5 |
| Sample F | 56,509 | 0.664 × 10⁴ | 0.269 × 10⁶ | 40.4 |

Activity = g PE/mmol Ti•hr 100 psi C₂H₄
PDI from SEC: Mw/Mn
Density = g/cm³

Gas Phase Polymerization Reactor

Catalyst were prepared according to the procedures described above, and are designated as Samples A-F. Polymerizations were conducted in a stirred gas phase reactor to prepare high molecular weight, high density bimodal ethylene-hexene copolymer. The conditions included the use of MMAO as the co-catalyst, 150 psig ethylene, hexene comonomer at 85° C. The results are shown in Table 2

TABLE 2

| | | | | Bulk | | | | |
|---|---|---|---|---|---|---|---|---|
| | Res. Ti, | Flow | Resin | dens. | Mn | Mw | | Density |
| Catalyst | ppm | Index | aps, in. | lb/ft³ | (10⁵) | (10⁵) | PDI | (g/cm³) |
| Sample | 1.2 | 2.23 | 0.0369 | 28.6 | 0.180 | 0.437 | 24.2 | 0.941 |
| B | | | | | | | | |
| Sample | 1.0; 1.2 | 1.63 | 0.0385 | 21.9 | 0.286 | 0.408 | 14.3 | 0.941 |
| A | | | | | | | | |
| Sample | 3.8, 3.1 | 23 | 0.027 | 23.5 | 0.973 | 0.294 | 31.4 | 0.948 |
| D | | | | | | | | |
| Sample | . . . | 10.2 | 0.036 | 24.8 | 0.446 | 0.194 | 43.4 | 0.944 |
| C | | | | | | | | |

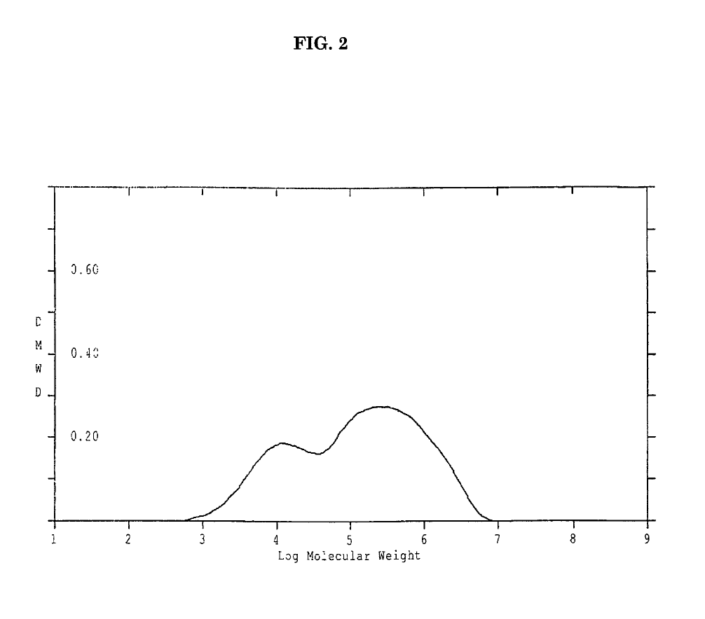

An SEC for the polymer produced in accordance with Sample B above is shown in FIG. 2.

Pilot Plant Gas Phase Experiments:

Samples A and B catalysts were run in a fluidized bed pilot plant reactor to make an ethylene-hexene copolymer at 130 psig ethylene, 80° C., with MMAO co-catalyst. The catalysts had high activity, good bulk density and gave the desired bimodal polyethylene.

Results are given in Table 3.

TABLE 3

| | Sample | Sample |
|---|---|---|
| Catalyst | B | A |
| Residual Ti, ppm | 1.01 | 1.04 |
| Resin aps, in. | 0.042 | 0.046 |
| Fines (through 120 | 7.0% | 4.67% |
| mesh) | | |
| Flow index | 8.7 | 9.1 |
| MFR (I21/I5) | 17.2 | 20.5 |
| Density (g/cm³) | 0.949 | 0.946 |
| Bulk density, lb/ft³ | 30.1 | 29.5 |

As can be seen by these examples, hybrid catalysts of the invention that contain a Ziegler-Natta portion and a metallocene portion whereby the metallocene portion is affixed to the Ziegler-Natta portion are capable of polymerizing olefins to produce a polyolefin having a broad molecular weight distribution. The catalysts of the invention also produce bimodal polyolefins in high yield. The molecular weight distribution of the polyolefins made using the hybrid catalysts of the present invention is broader than the molecular weight distribution that could be achieved by either the Ziegler-Natta catalyst or the metallocene catalyst alone.

While the invention has been described in detail with reference to particularly preferred embodiments, those skilled in the art will appreciate that various modifications can be made to the invention without significantly departing from the spirit and scope thereof.

What is claimed is:

1. A self-supported hybrid olefin polymerization catalyst comprising a Ziegler-Natta component and a metallocene component affixed to the Ziegler-Natta component, whereby the Ziegler-Natta component comprises a solid complex of at least magnesium, transition metal, and alkoxide, where the transition metal is selected from the group consisting of one or more metals having an oxidation state of +3, +4,+5, and mixtures thereof.

2. The self-supported hybrid olefin polymerization catalyst as claimed in claim 1, wherein the transition metal is selected from the group consisting of Ti (Ti⁺³ and Ti⁺⁴), Zr, V (V⁺⁴ and V⁺⁵), Sm, Fe, Sn and Hf.

3. The self-supported hybrid olefin polymerization catalyst as claimed in claim 1, wherein the metallocene component is selected from the group consisting of dimethylsilyl (biscyclopentadiene) zirconium dichloride (DMSBZ), bis(n-butylcyclopentadiene) zirconium dichloride (BuCpZ), dimethylsilyl (bis(n-propylcyclopentadiene)) zirconium dichloride (DMSPrCpZ), bis(n-propylcyclopentadiene)) zirconium dichloride (PrCpZ) and (cyclopentadiene) (indenyl) zirconium dichloride.

4. The self-supported hybrid olefin polymerization catalyst as claimed in claim 3, wherein the metallocene component is dimethylsilyl (biscyclopentadiene) zirconium dichloride.

5. A method of making a self-supported hybrid olefin polymerization catalyst as claimed in claim 1 comprising dissolving the metallocene component in a suitable solvent, adding the Ziegler-Natta component, mixing the two components together, and removing volatile materials from the mixture to thereby affix the metallocene component to the Ziegler-Natta component.

6. The method as claimed in claim 5, wherein the transition metal is selected from the group consisting of Ti (Ti⁺³ and Ti⁺⁴), Zr, V (V⁺⁴ and V⁺⁵), Sm, Fe, Sn and Hf.

7. The method as claimed in claim 5, wherein the metallocene component is selected from the group consisting of dimethylsilyl (biscyclopentadiene) zirconium dichloride (DMSBZ), bis(n-butylcyclopentadiene) zirconium dichloride (BuCpZ), dimethylsilyl (bis(n-propylcyclopentadiene)) zirconium dichloride (DMSPrCpZ), bis(n-propylcyclopentadiene)) zirconium dichloride (PrCpZ) and (cyclopentadiene) (indenyl) zirconium dichloride.

8. The method as claimed in claim 7, wherein the metallocene component is dimethylsilyl (biscyclopentadiene) zirconium dichloride.

9. A method of polymerizing at least one olefin comprising contacting at least one olefin in the presence of the catalyst of claim 1, an aluminum-containing compound and optionally, a selectivity control agent.

10. The method as claimed in claim 9, wherein the olefin is selected from the group consisting of ethylene, propylene, butylene, and mixtures thereof.
